(19) United States
(12) Patent Application Publication
(10) Pub. No.: US 2010/0245026 A1
(43) Pub. Date: Sep. 30, 2010

(54) FUSE LINK AND A FUSE

(75) Inventors: Shinichi Kobayashi, Saitama-shi (JP); Kengo Hirose, Tokyo (JP); Yuhzoh Ishikawa, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: National University Corporation Saitama University, Saitama-shi (JP)

(21) Appl. No.: 12/531,155

(22) PCT Filed: Mar. 12, 2008
(86) PCT No.: PCT/JP08/54513

§ 371 Date: Sep. 14, 2009

(30) Foreign Application Priority Data
Mar. 13, 2007 (JP) 2007-063966

(51) Int. Cl. H01H 85/046

(52) U.S. Cl. 337/293

(57) ABSTRACT

According to the present invention, n (n=S is a positive integer) pieces of interrupting grids (22₋₁, 22₋₂, 22₋₃, - - - , 22₋₍ₙ₋₁₎ and 22₋ₙ) are provided, each of the interrupting grids encompasses P pieces of narrow cut-off canals arranged in parallel. The both side of each of the narrow cut-off canals are concaved so that the narrow cut-off canal has a waisted-mortar shape. The waisted-mortar shape is delineated by m pieces of elliptical holes (Q₁, Q₂, Q₃, - - - , Qₘ₋₁ and Qₘ (m=P−1 is a positive integer)) arranged adjacently in parallel and semi-elliptical holes (cut ID portions) provided on both sides the alignment of elliptical holes. Then, n pieces of the interrupting grids 22₋₁, 22₋₂, 22₋₃, - - - , 22₋₍ₙ₋₁₎ and 22₋ₙ are arranged in series through jointing zones (heat-radiation zones) (21₋₁, 21₋₂, 21₋₃, - - - , 21₋₍ₙ₋₎ and 21₋ₙ) having a length of 2.5 millimeters or less measured in the series direction. A thickness of each of the interrupting grids is t_{H}=10-60 micrometers, and a thickness of each of the jointing zones (heat-radiation zones) is t_{R}=80-150 micrometers.

### FIELD OF THE INVENTION

The present invention relates to fuse links used in fuses for protecting semiconductor switching devices such as a GTO thyristor, an IGBT and the like, and relates to the fuse that uses the fuse link or the fuse links.

### DESCRIPTION OF THE RELATED ART

As compared with the remarkable development of semiconductor switching devices, protecting fuses for protecting the semiconductor switching devices have been developed behind the semiconductor switching devices at all times. In the fuses for protecting the semiconductor devices, an I²t value is defined as an integration of the square values (I²dt), where the cut-off currents I is read in oscillogram waveforms of its current-interruption experiment, from current-interruption time 0 to t. Then, comparing various fuses at the same rating, a fuse having a smaller I²t value is determined to have the better performance. Also, a fuse element is fabricated by arraying a plurality of unit-fuses in parallel so as to form a unit zone (an interrupting grid) and then connecting the S pieces of interrupting grids in series. That is, the parallel number of the narrow cut-off canals establishing the interrupting grid is represented as “P-value”, and the series number of the interrupting grids arrayed in series is referred to as “S-value”. When the fuse element is designed, the S-value is determined so as to establish a desired rated voltage, and the P-value is determined so as to establish a desired rated current. For more than 20 years, as the representative earlier-scheme values, 1−1.25/100V for the S-value and 1-10 P/cm for the P-value have been maintained.

As the fuses for protecting the semiconductor devices, in earlier technology, fuse elements of silver-ribbon press architecture have been known. For example, a structure is known in which three circular holes are opened adjacently in parallel on a silver (Ag) ribbon by using a press mold, and semicircular recesses are further formed on both sides of the alignment of three circular holes in the silver ribbon so as to delineate four narrow cut-off canals, implementing an interrupting grid, and then the interrupting grid where the four unit-fuses are arrayed in parallel, and the five series sets of the interrupting grids are further arrayed in series through jointing zones (heat-radiation zones). This configuration is represented as “5S4P-configuration” because the five narrow cut-off canals, each having the narrowed sectional area of the silver ribbon, are arrayed in series, and the four unit-fuses are arrayed in parallel. The fuse elements of the silver-ribbon press architecture are installed in a fuse cylinder so as to be embedded in the arc-extinguishing sand in the fuse cylinder. A driving current usually flows through the fuse element. However, when an accidental abnormal current is generated, each narrow cut-off canal, in which the sectional area is small and the resistance value is high, is melted, and an arc voltage is made high, and the accidental abnormal current is quickly cut off. As for the fuse element of the silver-ribbon press architecture, the fuse element whose rating exceeds AC 8000 V and a current of 3000 A is recently manufactured. However, there is the fuse element that has a large size and costs 200,000 yens or more. However, because the fuse element of the earlier silver-ribbon press architecture has the limits of a plate thickness of 150 micrometers and a line width of 150 micrometers, the limit in the reduction scheme of the I²t value, the limit of the cost-reducing scheme and the limit of the miniaturization methodology are considered to be becoming significant.

For this reason, for the fuse element of the silver-ribbon press architecture as mentioned above, this inventor proposed an etched fuse element (refer to a patent document 1). The etched fuse element is delineated such that a conductive thin film is formed on the surface of a ceramic substrate, which has an electrically insulating property and has a geometry of a rectangular plate, and similarly to the fuse element of the silver-ribbon press architecture, the etched fuse element is installed in a fuse cylinder and embedded in the arc-extinguishing sand inside the fuse cylinder. The conductive thin film is made of copper foil, silver foil and the like, and a pattern of an array of the narrow cut-off canals is delineated by etching. For example, a structure such that five narrow cut-off canals are delineated by four elliptical holes arranged adjacently in parallel and semicircular recesses (cut portions) on both sides of the alignment of the four elliptical holes, and the interrupting grid in which the four unit-fuses are consequently arrayed in parallel, and the five sets of the interrupting grids are further arrayed in series through the jointing zones (heat-radiation zones) can be fabricated by the etching is known. In this case, from the foregoing definition, the pattern of “5S5P-configuration” is formed. The driving current usually flows through the conductive thin film of the fuse element. However, when an accidental abnormal current is generated, each narrow cut-off canal in which the sectional area is small and the resistance value is high is melted, and the arc voltage is made high, and the accidental abnormal current is quickly cut-off. The earlier etched fuse was considered to have the limits of a film thickness of 30-60 micrometers and a line width of about 100 micrometers. In particular, the length of three millimeters measured in the series direction of the jointing zones (heat-radiation zones) through which a plurality of interrupting grids are connected is considered to be required. For this reason, the maximum of the S-value is considered to be about 8S in a rated voltage of 600V class. Then, the limit of the drop in the I²t value, the limit of the cost-reducing scheme and the limit of the miniaturization methodology become significant. Although the earlier etched fuse element having a S-value of 1/100V and a P-value of 10 P/cm is produced and marketed, which has a smaller size and a higher performance than the fuse element of the silver-ribbon press architecture, because the cost of the earlier etched fuse element is slightly higher, the sale of the earlier etched fuse element remains sluggish. Also in EU, irrespectively of the continuation of the basic research in the etched fuse element, the reason why the practical implementation of the earlier etched fuse element is not attained seems to result from the same cause as discussed above.

Patent Document 1:
Japanese Laid Open Patent Application (JP-P 2006-73331A)

### SUMMARY OF THE INVENTION

### Problems to be Solved by the Invention

FIG. 2(a) is a cross-sectional view detailing the structure of the unit-fuse implementing the etched fuse. Also, FIG. 2(b) is a plan view detailing the structures of the four unit-fuses, correspondingly to FIG. 2(a). That is, FIG. 2 illustrates that the unit-fuse encompasses an narrow cut-off canal 22₋ₖ having a geometry concaved into a waisted-mortar shape so as to exhibit a thickness of t_{H}, a length H measured in the series direction, a minimum width b measured in the parallel direction, and the maximum width B and a rectangular jointing zone (heat-radiation zone) 21₋ₖ connected to the narrow cut-off canal 22₋ₖ having a thickness t_{R}, a length R measured in the series direction and a width B measured in the parallel direction. Thus, measured in the series direction, a length P_{L} of the unit-fuse is obtained as P_{L}=H+R.

As shown in FIG. 3, with a length L measured in the series direction of the fuse link, a width W measured in the parallel direction of the fuse link, and a length T measured in the series direction of each of terminal portions 11, 12, the following equations are obtained by using a dividing P-value and a dividing S-value:

B=W/P (1)

P_{L}=H+R=(L−2T)/S (2)

In the earlier technology, in order to improve the current-interruption performance of the fuses, a scheme of increasing the current-interruption points was tried. However, in a scheme of increasing the S-value and increasing the series current-interruption points of the fuses, the large jointing zone (heat-radiation zone) 21₋ₖ of the length R measured in the series direction is required between the two series current-interruption points. Unless there is a large jointing zone (heat-radiation zone) 21₋ₖ of the length R, two arcs mutually extending towards the inside of the jointing zone (heat-radiation zone) 21₋ₖ from the ends of both sides in the series direction of the jointing zone (heat-radiation zone) 21₋ₖ become a single arc soon after the generation of two arcs. In particular, when it takes a considerable time to current-interrupt, the two arcs extending towards the inside of the jointing zone (heat-radiation zone) 21₋ₖ from the ends of both the sides in the series direction of the jointing zone (heat-radiation zone) 21₋ₖ are progressed, the two arcs erode and extinguish the jointing zone (heat-radiation zone) 21₋ₖ, and as two arcs are coalesced into a single arc, the current-interruption becomes impossible. Also, the existence of the larger jointing zone (heat-radiation zone) 21₋ₖ of the length R enables the smaller width b of the narrow cut-off canal 22₋ₖ, the large length of R becomes the conclusive feature for improving the I²t performance.

Thus, in the etched fuse, it is the most important feature to reserve the length R of the jointing zone (heat-radiation zone) 21₋ₖ so that the jointing zone is not extinguished. In the earlier technology, R=3 millimeters was considered to be the minimum value. The development of the fuse is always under superheated competition, and there is the limited length even in the length (entire length) L measured in the series direction of the fuse link. Thus, it is very difficult to increase the S-value while reserving the length R of the jointing zone (heat-radiation zone) 21₋ₖ and to increase the current-interruption points. A fact that the number of the current-interruption points remains between 1 and 1.2 per 100V in recent decades proves the difficulty of increasing the S-value.

Also, as the increase in the dividing S-value and the increase in the series current-interruption points result in the increase in the resistance of the entire fuse element, the rated current value becomes small. In order to increase the rated current value, because increase of a total minimum sectional area ΣS=bP of the fuse link that corresponds to the total sum (Σ) of the sectional areas S of the narrow cut-off canals in the narrow cut-off canal 22₋ₖ leads to the increase in the I²t value that is the most important characteristic of the fuse for protecting the semiconductor device, the increase of a total minimum sectional area ΣS=bP is not absolutely allowed. From the issue stated above, only the dividing S-value cannot be easily increased.

In this way, in the earlier technology, although it was a long-felt need to improve the current-interruption performance of the fuse by increasing the S-value, because there was actually no example of achieving the increase of the S-value, the increase of the S-value is remained as an unsolved technical problem for long years.

In view of the above-mentioned problems, it is therefore an object of the present invention to provide a fuse link having a smaller I²t value, with a reduced manufacturing cost, of which the miniaturization of scale is easily achieved, and a fuse using the fuse link.

### Means to Solve the Problems

In order to attain the above-mentioned object, a first aspect of the present invention inheres in a fuse link encompassing an insulating substrate and a pattern of a conductive thin film formed on a surface of the insulating substrate. Here, the pattern of the conductive thin film includes a plurality of patterns of interrupting grids, each of which having a plurality of narrow cut-off canals arranged in parallel, and a plurality of patterns of jointing zones connecting the interrupting grids alternately and cyclically so that the interrupting grids are arrayed in series through jointing zones. And each of the interrupting grid has a thickness between 10 and 60 micrometers, each of the jointing zone has a thickness between 80 and 150 micrometers, and a length measured in the series direction of the jointing zone is 2.5 millimeters or less. When the fine-process capability is considered, the interrupting grid is preferred to have the thickness between 10 and 40 micrometers. Moreover, in order to increase the dividing P-value and the dividing S-value, the interrupting grid is preferred to have the thickness between about 10 and 30 micrometers.

A second aspect of the present invention inheres in a fuse encompassing an insulating tube serving as a fuse cylinder and a fuse link installed in the insulating tube. Here, the fuse link has an insulating substrate, and a pattern of a conductive thin film formed on a surface of the insulating substrate. The pattern of the conductive thin film includes a plurality of patterns of interrupting grids, each of which having a plurality of narrow cut-off canals arranged in parallel, and a plurality of patterns of jointing zones connecting the interrupting grids alternately and cyclically so that the interrupting grids are arrayed in series through jointing zones, and each of the interrupting grid has a thickness between 10 and 60 micrometers, each of the jointing zone has a thickness between 80 and 150 micrometers, and a length measured in the series direction of the jointing zone is 2.5 millimeters or less.

### EFFECTIVENESS OF THE INVENTION

According to the present invention, it is possible to provide a fuse link having a smaller I²t value, with a reduced manufacturing cost, of which the miniaturization of scale is easily achieved, and a fuse using the fuse link.

### BRIEF DESCRIPTION OF THE DRAWINGS

FIG. 1 is a diagrammatic plan view (top view) describing the schematic configuration of a fuse link pertaining to an embodiment of the present invention;

FIG. 2(a) is a cross-sectional view detailing the structure (three-dimensional structure) of the unit-fuse implementing the etched fuse, and FIG. 2(b) is a plan view detailing the structure of the four unit-fuses, correspondingly to FIG. 2(a);

FIG. 3 is a diagrammatic plan view (top view) describing the entire relation between the unit-fuses and the fuse link;

FIG. 4 is a diagrammatic view illustrating the surface patterns of the fuse links of five kinds, with dividing S-values of S=4, 8, 12, 16 and 24, respectively, at dividing P-value P=8, entire melting-length L=34 millimeters, and entire melting-width W=eight millimeters;

FIG. 5 is a view illustrating the dividing S-value dependence characteristic of each of the I²t values, for series resistances (entire resistances) rₑ=1.5 milliohms, 3 milliohms, and five milliohms of the AC600V fuse link, respectively;

FIG. 6 is a view describing an S-P synergistic effect by indicating the dividing S-value dependence characteristic of each of the I²t values, for the AC600V fuse links with dividing P-values of P=8 and P=32 (the width of the interrupting grid measured in the parallel arrangement direction is eight millimeters);

FIG. 7 is a view describing the dividing P-value dependence characteristic of the I²t value, for the AC600V fuse link at dividing S-value of S=6 (the width of the interrupting grid measured in the parallel arrangement direction is eight millimeters);

FIG. 8 is a view illustrating the dividing P-value dependence characteristic of the normalized Pt value, for the AC600V fuse link at dividing S-value of S=6, wherein the I²t value of the fuse link of a 6S5P-configuration is defined as 100% for normalization;

FIG. 9(a) illustrates a voltage waveform of an oscillogram of a current-interruption experiment of the AC600V fuse link at dividing S-value of S=6 and dividing P-value of P=32 (6S32P-configuration), and FIG. 9(b) illustrates the corresponding current waveform;

FIG. 10(a) illustrates an oscillogram waveform of a current-interruption experiment of the AC600V fuse link at dividing S-value S=16 and dividing P-value P=8 (16S8P-configuration), and FIG. 10(b) illustrates the corresponding current waveform;

FIG. 11(a) illustrates an oscillogram waveform of a current-interruption experiment of the AC600V fuse link at dividing S-value S=24 and dividing P-value P=8 (24S8P-configuration), and FIG. 11(b) illustrates the corresponding current waveform;

FIG. 12 is a diagrammatic view illustrating one arc voltage Vₐᵢ and an electrode drop voltage Vₚᵢ, focusing on a single unit-fuse in the fuse link pertaining to the embodiment of the present invention;

FIG. 13 is a view illustrating an operation overvoltage value Vₘ (characteristic curve A), a total electrode drop value ΣVₚᵢ (characteristic curve B) and an electrode drop characteristic Vₚ (characteristic curve C) of the unit-fuse, calculated from a model shown in FIG. 12;

FIG. 14 is a graph in which an abscissa indicates the dividing P-values and the dividing S-values are represented parameters, such that linear approximations of the I²t values are illustrated on a double logarithm graph; and

FIG. 15(a) is a diagrammatic cross-sectional view illustrating the packaged structure of the fuse link pertaining to the embodiment of the present invention, and FIG. 15(b) is a view illustrating the three fuse links installed (inserted) in inner caps.

### DETAILED DESCRIPTION OF THE INVENTION

An embodiment of the present invention will be described below with reference to the drawings. In the illustrations of the following drawings, the same or similar reference numerals are given to the same or similar portions. However, attention should be paid to the fact that, since the drawings are only diagrammatic, the relation between the thickness and the flat surface dimension, and the ratio between the thicknesses of respective layers, and the like differ from the actual members. Thus, the specific thicknesses and dimensions should be judged by referring to the following descriptions. Also, of course, the portions in which the mutual dimensional relations and ratios are different are included even between the mutual drawings.

Also, the following embodiment only exemplifies the apparatus and method that embody the technical idea of the present invention. In the technical idea of the present invention, the materials, shapes, structures, arrangements and the like of the configuration parts are not limited to the following items. Various modifications can be applied to the technical idea of the present invention, within the technical scope described in claims.

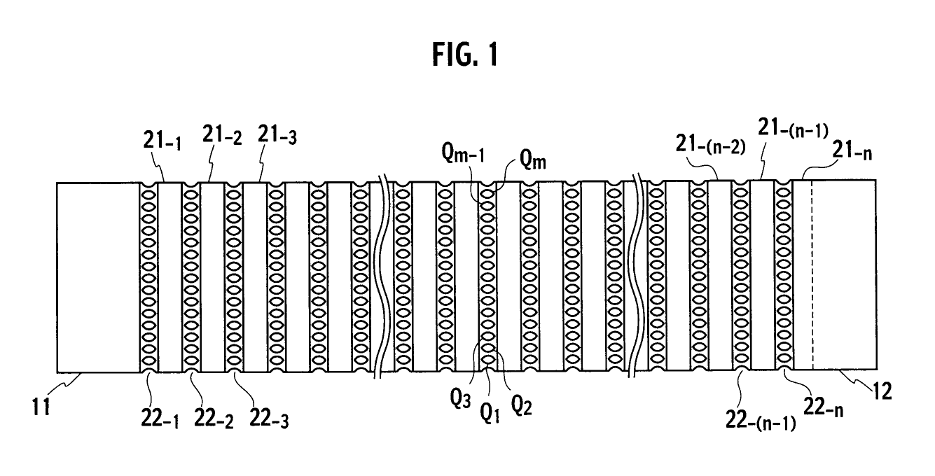

As shown in FIG. 1, in a fuse link pertaining to an embodiment of the present invention, n (n=S is a positive integer) pieces of interrupting grids 22₋₁, 22₋₂, 22₋₃, - - - , 22₋₍ₙ₋₁₎ and 22₋ₙ are provided, each of the interrupting grids 22₋₁, 22₋₂, 22₋₃, - - - , 22₋₍ₙ₋₁₎ and 22₋ₙ encompasses P pieces of narrow cut-off canals arranged in parallel. The both side of each of the narrow cut-off canals are concaved so that the narrow cut-off canal has a waisted-mortar shape. The waisted-mortar shape is delineated by m pieces of elliptical holes Q₁, Q₂, Q₃, - - - , Qₘ₋₁ and Qₘ (m=P−1 is a positive integer) arranged adjacently in parallel and semi-elliptical holes (cut portions) provided on both sides the alignment of elliptical holes Q₁, Q₂, Q₃, - - - , Qₘ₋₁ and Qₘ. Then, n pieces of the interrupting grids 22₋₁, 22₋₂, 22₋₃, . . . , 22₋₍ₙ₋₁₎ and 22₋ₙ are arranged in series through jointing zones (heat-radiation zones) 21₋₁, 21₋₂, 21₋₃, - - - , 21₋₍ₙ₋₎ and 21₋ₙ, each of jointing zones 21₋₁, 21₋₂, 21₋₃, - - - , 21₋₍ₙ₋₎ and 21₋ₙ having a length of 2.5 millimeters or less measured in the series direction. Terminal portions 11, 12 are provided on both ends of the fuse link in an orientation measured in the series direction. According to the definition described at the introduction section of the Specification, the configuration of the etched fuse has a pattern of S=n, P=m+1 (or called as “nS (m+1)P-configuration”).

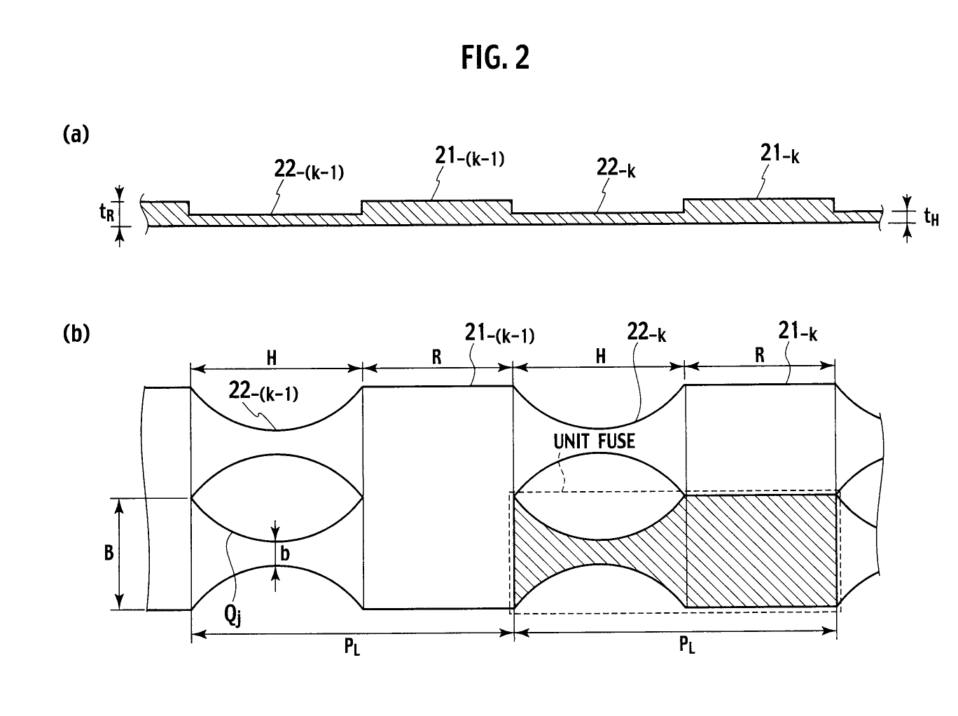

When the structure of the fuse link pertaining to the embodiment of the present invention is described by the definitions of the thicknesses shown in FIG. 2(a), the fuse link is characterized by a feature such that a thickness of each of the interrupting grids 22₋₁, 22₋₂, 22₋₃, . . . , 22₋₍ₙ₋₁₎ and 22₋ₙ is t_{H}=10-60 micrometers, and a thickness of each of the jointing zones (heat-radiation zones) 21₋₁, 21₋₂, 21₋₃, - - - , 21₋₍ₙ₋₎ and 21₋ₙ is t_{R}=80-150 micrometers. The minimum width b of the narrow cut-off canal depends on the thickness t_{H} of the interrupting grid. Thus, when the fine-process capability is considered, the thickness t_{H} of the interrupting grid is preferred to be 10-40 micrometers. Moreover, in order to increase the dividing P-value and the dividing S-value, maintaining each of an entire melting-width W=ΣBⱼ and an entire melting-length L=ΣP_{Li} constant, the thickness t_{H} of the interrupting grid is preferred to be about 10-30 micrometers. The minimum width b of the narrow cut-off canal can be approximately decreased to the thickness t_{H} of the interrupting grid in theory. However, when the variation of the processing accuracy in dimension is considered, it is preferred to be about two times the thickness t_{H} of the interrupting grid. Thus, when the thickness t_{H} of the interrupting grid is assumed to be about 30 micrometers, the minimum width b=60 micrometers of the narrow cut-off canal can be processed by etching, and when the thickness t_{H} of the interrupting grid is assumed to be about 10 micrometers, the minimum width b=20 micrometers of the narrow cut-off canal can be processed by etching.

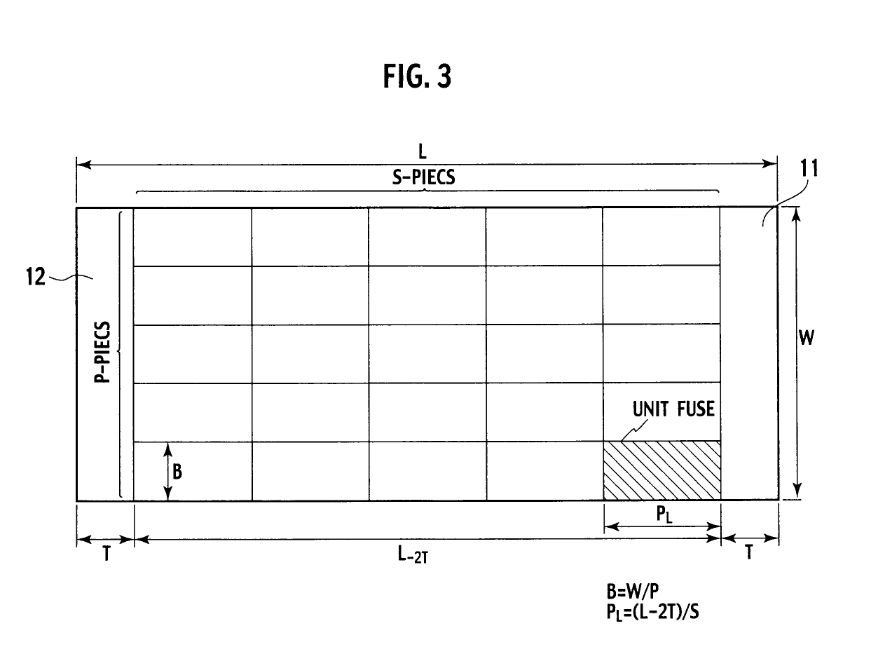

In the earlier technology, as the common sense, when two 100V fuse links were connected in series, the connected fuse links could be used as a 200V fuse link, and in a case that a 600V fuse could be attained in 6S-configuration, when the series number was increased up to 60S-configuration, the 60S-configuration can facilitate the design of the fuse of about 6000V. In the earlier technology, the improvement of performances of fuse links such that when 6S-configuration is changed to 7S-configuration, or such that 69S-configuration is changed to 79S-configuration, is referred as “S-effect”. On the contrary, “S-Division Effect” of the present invention implies the improvement of a performance of a fuse link when an entire melting-length L=ΣPLᵢ shown in FIG. 3 is divided into S pieces, while maintaining the entire melting-length L constant.

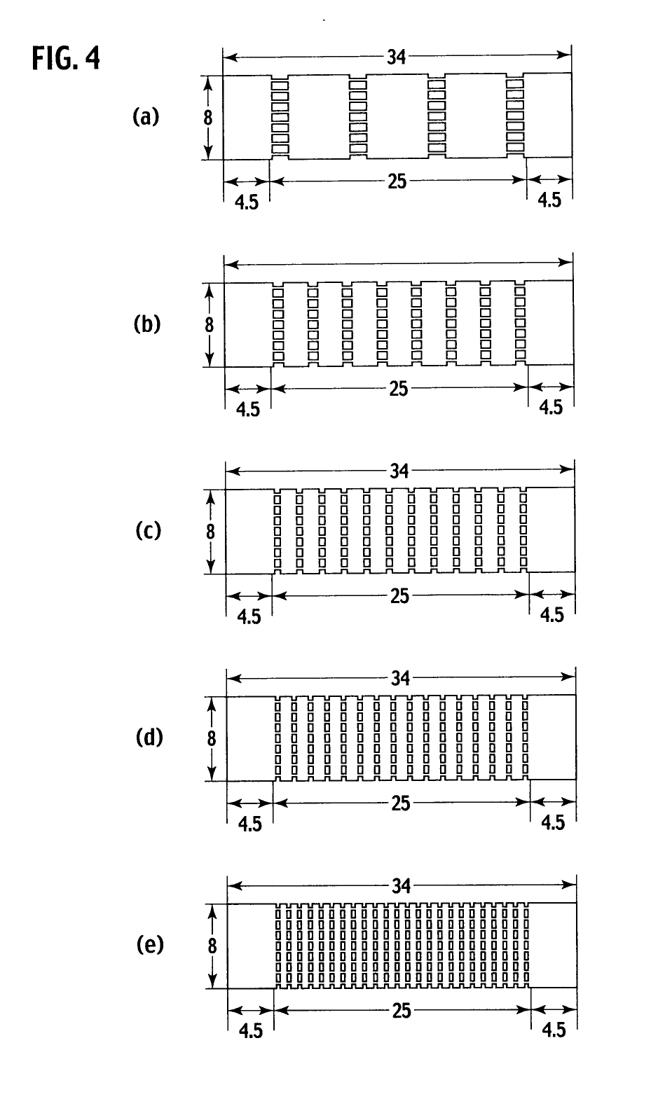

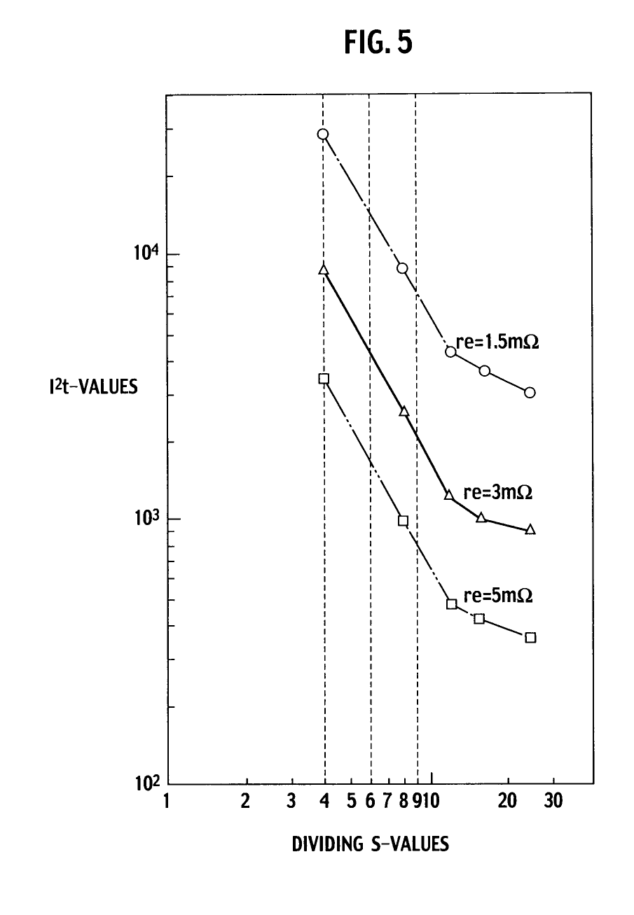

FIG. 4 illustrates five kinds of S-division configurations, in which the parallel number is kept constant as 8P and the entire melting-length is kept constant as L=34 millimeters. Although, the example of P=16 and S=16 is shown in FIG. 1, FIG. 4 illustrates various configurations with the dividing S-values of S=4, 8, 12, 16 and 24. In FIG. 1 and FIG. 5, the width (entire melting-width) of the interrupting grid is kept constant as W=8 millimeters, measured in the parallel arrangement direction. That is, FIG. 4(a) illustrates a fuse pattern of a 4S8P-configuration, FIG. 4(b) illustrates a fuse pattern of an 8S8P-configuration, FIG. 4(c) illustrates a fuse pattern of a 12S8P-configuration, FIG. 4(d) illustrates a fuse pattern of a 16S8P-configuration, and FIG. 4(e) illustrates a fuse pattern of a 24S8P-configuration.

In the fuse link pertaining to the embodiment of the present invention, each thickness t_{R} of the jointing zones (heat-radiation zones) 21₋₁, 21₋₂, 21₋₃, - - - , 21₋₍ₙ₋₎ and 21₋ₙ is made thick, and each resistance value of the jointing zones (heat-radiation zones) 21₋₁, 21₋₂, 21₋₃, - - - , 21₋₍ₙ₋₎ and 21₋ₙ is made small, and each mass of the jointing zones (heat-radiation zones) 21₋₁, 21₋₂, 21₋₃, - - - , 21₋₍ₙ₋₎ and 21₋ₙ is made heavy. Thus, as shown in FIG. 4, even if the entire melting-length L=is constant, the dividing S-value can be increased, and each length R of the jointing zones (heat-radiation zones) 21₋₁, 21₋₂, 21₋₃, - - - , 21₋₍ₙ₋₎ and 21₋ₙ can be made small, while the existence of the jointing zones (heat-radiation zones) 21₋₁, 21₋₂, 21₋₃, - - - , 21₋₍ₙ₋₎ and 21₋ₙ can be maintained.

Table 1 illustrates summary of the experimental result of the fuse links of the five kinds, such as the dividing S-values of S=4, 8, 12, 16 and 24, in the case of the parallel number of 8P, the entire melting-length L=34 millimeters and the entire melting-width W=eight millimeters.

TABLE 1

| | total | operation | recovery | cut-off | total | equivalent I²t |
|---|---|---|---|---|---|---|
| | resistance | overvoltage | voltage | current | I²T | normalized at 5 milliohms, |
| pattern | (milliohm) | Vₘ(V) | Vₒ(V) | Iₘ(A) | (A²s) | (A²s) |
| 4S-8P | 4.3 | 918 | 850 | 2275 | 4604 | 3405 |
| 8S-8P | 5 | 1072 | 850 | 2025 | 1012 | 1012 |
| 12S-8P | 5.4 | 1374 | 850 | 1938 | 903 | 470 |
| 16S-8P | 5.8 | 1347 | 850 | 1989 | 329 | 443 |
| 24S-8P | 6.6 | 1938 | 850 | 1991 | 224 | 390 |

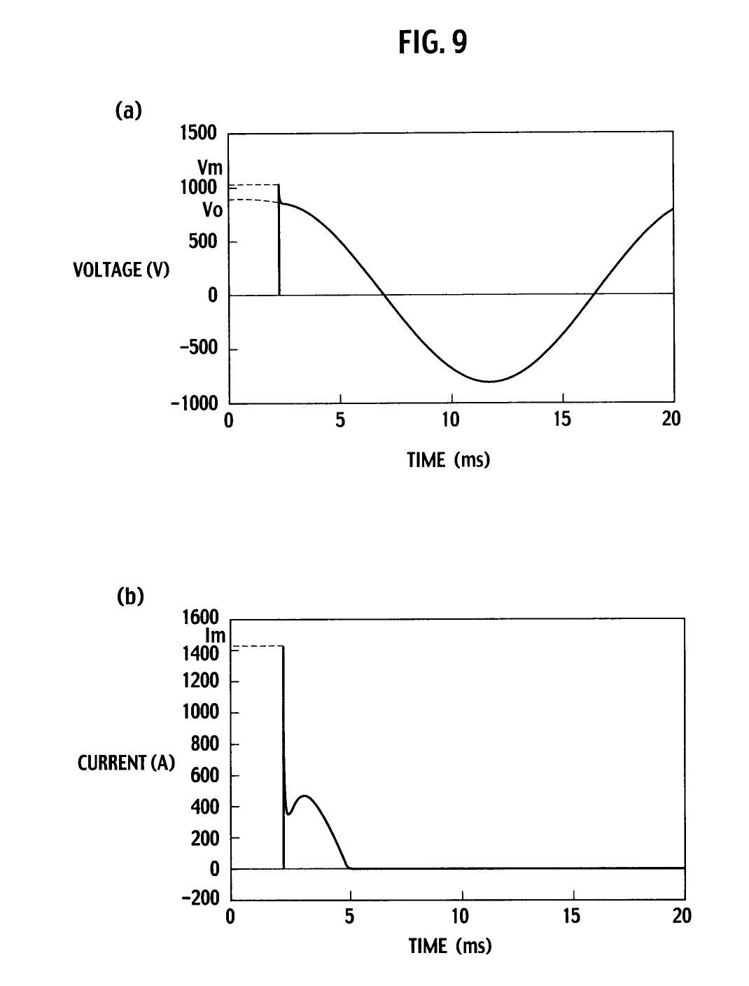

As illustrated in Table 1, the operation overvoltage Vₘ (for the definition of “Operation Overvoltage Vₘ”, refer to FIGS. 9 to 11) increases with the dividing S-values and reaches a maximum value, which is 2.1 times of the 4S-8P configuration. On the contrary, the cut-off current value Iₘ (for the definition of “Cut-off Current Value Iₘ”, refer to FIGS. 9 to 11) decreases with the dividing S-values and reaches a minimum value, which is 87.5% of the 4S-8P configuration, and the contribution of the S-divisional effect is not so great. The total I²t value is inversely proportional to the value of the operation overvoltage Vₘ and decreases with the dividing S-values and reaches a minimum value, which is 1/20 of the 4S-8P configuration, and illustrates a large significance of the S-divisional effect on the total I²t value.

Table 2 illustrates the experimental result in a case when the dividing P-value is kept to be ³²P and the dividing S-values are changed as S=4, 8, 12, 16 and 24, representing a further large significance of the S-divisional effect on the total I²t value.

TABLE 2

| | total | operation | recovery | cut-off | total | equivalent I²t |
|---|---|---|---|---|---|---|
| | resistance | overvoltage | voltage | current | I²T | normalized at 5 milliohms |
| pattern | (milliohm) | Vₘ(V) | Vₒ(V) | Iₘ(A) | (A²s) | (A²s) |
| 4S-32P | 4.4 | 918 | 850 | 2054 | 4166 | 3226 |
| 8S-32P | 5.6 | 1066 | 850 | 1345 | 538 | 675 |
| 12S-32P | 6.1 | 1176 | 850 | 1228 | 167 | 249 |
| 16S-32P | 5.8 | 1256 | 850 | 1392 | 123 | 166 |
| 24S-32P | 6 | 1307 | 850 | 1318 | 79 | 114 |

Also, according to the fuse link pertaining to the embodiment of the present invention, because a thickness t_{H} of each of the interrupting grids 22₋₁, 22₋₂, 22₋₃, . . . , 22₋₍ₙ₋₁₎ and 22₋ₙ can be made thin, while the total minimum sectional area ΣS is kept as a constant value, the dividing P-value can be made high so as to increase the P-divisional effect, and the dividing S-value can be also made high so as to make the best use of the S-divisional effect, the I²t value is reduced to 1/10 of the value of the earlier fuse. As for “P-effect”, in the earlier common sense, when the P-value increases, because the total minimum sectional area ΣS increases, the I²t value increases so as to deteriorate the I²t performance. “P-divisional effect” in the present invention shall be construed as a technical advantage achieved by a configuration such that, when the total minimum sectional area ΣS is kept constant, the fuse link is divided into P pieces in a parallel direction. That is, in the fuse link pertaining to the embodiment of the present invention, while the total minimum sectional area ΣS is kept at a constant value, because the dividing P-value can be increased freely, as the dividing P-values increase at larger values, the I²t values of the fuse link can be decrease to smaller values, thereby improving the I²t performance. Hence, “P-divisional effect” exhibits a reverse phenomenon of the “P-effect”, from the viewpoint of the earlier common sense.

For example, as for a grounding resistance, when the number of grounding rods increases, the grounding resistance decreases. When the number of the grounding rods is changed from one to two, the total grounding resistance is reduced to ½. However, even if the number of the grounding rods is increased up to ten, the total grounding resistance is not reduced to 1/10. The reason why the total grounding resistance is not reduced to 1/10 ascribable to an existence of the interference that increases the mutual ground potentials gradually, and the interference reduces the effectiveness of the increase in the number of the grounding rods. All of the foregoing phenomena of the grounding resistance are similar to the P-divisional effect of the fuse link. In short, because all of thermal circuits can be replaced by electric circuits, when the grounding resistance is replaced by the thermal resistance, and the electrical potential is replaced by the thermal potential, the problems of the cooling performance of the fuse link pertaining to the embodiment of the present invention can be speculated by the grounding resistance calculation equation, such that the issue of a fuse link can be described equal to the issue of the grounding resistance.

That is, as the number of the grounding rods is replaced with the number P of the narrow cut-off canals in the fuse link, when the dividing P-value of the fuse link increases, because the cooling performance of the fuse link improves, even if the total minimum sectional area ΣS of the fuse link is kept at a constant value, the larger current can be driven in the fuse link. As a result, the fuse link whose rated current value is large can be provided. Since the I²t performance of the fuse link should be compared at an equal rated current value, as the dividing P-value of the fuse link increases, because the rated current value can be made kept at a constant value even if the ΣS of the fuse link is further decreased, the I²t value of the fuse link can be decreased by the value correspondingly to the decrease in the ΣS.

As shown in FIG. 1, the fuse link pertaining to the embodiment of the present invention encompasses the pattern of the conductive thin film formed on the insulating substrate such as the ceramic substrate whose thickness is between 0.8 millimeter and 1.5 millimeters and the like. As the materials of the ceramic substrate, it is possible to use alumina (Al₂O₃), mullite (3Al₂O₃.2SiO₂), beryllia (BeO), aluminum nitride (AlN), silicon carbide (SiC) and the like. As the conductive thin film, the metallic thin film, especially, copper (Cu) is preferred in view of the lower cost and the easiness of the processing, but the materials of the conductive thin film is not limited to the copper. In the case of the metallic thin film, especially, the thin film made of the copper, the pattern of the fuse link pertaining to the embodiment of the present invention can be easily delineated by plating the copper (Cu) and etching. That is, after the copper of the thickness t_{H}=10-60 micrometers is thinly plated on the ceramic substrate so that the interrupting grids 22₋₁, 22₋₂, 22₋₃, . . . , 22₋₍ₙ₋₁₎ and 22₋ₙ are delineated, the additional plating shall be performed until each of the jointing zones (heat-radiation zones) 21₋₁, 21₋₂, 21₋₃, - - - , 21₋₍ₙ₋₎ and 21₋ₙ reaches the thickness t_{R}=80-150 micrometers.

FIG. 5 illustrates the dividing S-value dependence characteristics of the I²t values, when the series resistances (total resistances) of the fuse links are rₑ=1.5 milliohms, three milliohms and five milliohms, respectively. For example, in the case of the series resistance (total resistance) rₑ=five milliohms, I²t=350 is illustrated at S=24, which represents that the I²t value is reduced to 1/10 of the value at S=4.

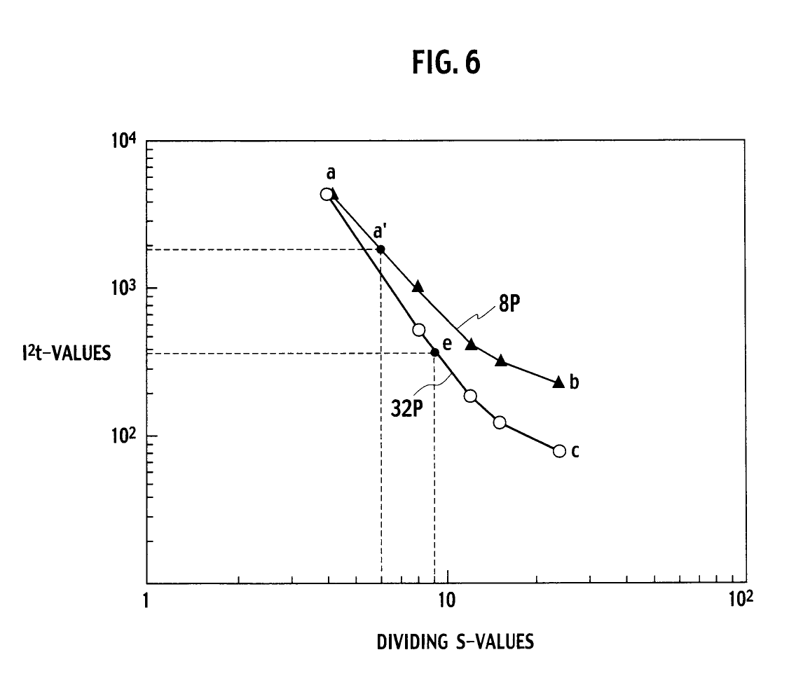

FIG. 6 illustrates the dividing S-value dependence characteristics of the total I²t values, respectively, in the cases of P=8 and P=32. Because the case of P=32 has a stronger dividing S-value dependence characteristics of the total I²t values than the case of P=8, and a synergistic effect of the dividing S-value and the dividing P-value is recognized. In FIG. 6, the width of the interrupting grid measured in the parallel arrangement direction is eight millimeters. In the case of P=8, because at S=4 indicated by the point “a” in FIG. 6, the total I²t=4500, and at S=24 indicated by the point “b”, the total I²t=240, the improvement of the total I²t value such that b/a=1/19 is recognized. On the other hand, in the case of P=32, because at S=4 indicated by the point “a” in FIG. 6, the total I²t=4500, and at S=24 indicated by the point “c”, the total I²t=80, the improvement of the total I²t value such that c/a=1/56 is recognized. Hence, with the S-P synergistic effect, as the dividing P-value becomes higher, the higher improvement can be achieved such that the total I²t value increases more significantly with the increase of the dividing S-value. At present, in the conventional AC600V fuse, S=6, P=8 (6S8P-configuration) is said to be the high performance fuse. However, since the total I²t=188 of the 6S8P-configuration, which is indicated by the point “a′” in FIG. 6, the improvement of the total I²t value is such that c/a′=1/13, the significant improvement of the total I²t value over one digit or more is recognized by the S-P synergistic effect.

As mentioned above, according to the fuse link pertaining to the embodiment of the present invention, it is possible to provide fuse links that have the dividing S-values equal to or higher than 1.5/100V, which exceed the earlier common sense values of (1−1.2)/100V. Here, “Dividing S-value equal to or higher than 1.5/100V” indicates that the dividing S-value is 1.5 or more per effective voltage of 100 V. From FIG. 5 and FIG. 6, it is represented that the present invention can provide the fuse links having the dividing S-values of 2/100V or more.

In FIG. 6, when the performance of the actually-used fuse is considered to be close to the point “a′” of the 6S8P-configuration, the equivalent I²t value becomes 1600 A²s normalized at five milliohms. Then, if the equivalent I²t value of 1600 A²s is assigned as 100%, because the total I²t value=79 A²s in 6 milliohm of the point “c” (24S32P) becomes 114 A²s with respect to the equivalent Pt value normalized at five milliohms (refer to Table 2), the value of 114 A²s corresponds to 7.1% of the value at the point “a′”. In this way, the very small I²t value of 10% or less becomes an excessively low value that is practically unnecessary, in many cases. Thus, in view of the industrial viewpoint, it is practically necessary to increase the minimum sectional area and consequently increase the rated current and consider the cost-down.

Because the fuse link of the present invention is required to be three-dimensionally fabricated and further required to be finely processed, the manufacturing cost of the fuse link is estimated to increase up to at least 1.5 times of the cost of the earlier technology. With the same fuse-housing, if the rated current value can be increased to 1.5 times, it is possible to compensate the cost-increase caused by the three-dimensional structure of the fuse link of the present invention, and by further reduction of the fuse-housing cost and the assembling labor charge corresponding to the practically-used apparatus, a further cost-down can be progressed. So, in order to attain the rated current of 1.5 times, the resistance value must be reduced to 1/1.5². As this result, by increasing the narrow cut-off canal sectional area up to (1.5)²=2.25 times, the I²t value can be increased up to (2.25)²=5.06 times.

On the characteristic curve of the dividing P-value=32P in FIG. 6, although the data point for 1.5/100V is missing, an interpolation point (point “e”) of the dividing S-value=9S corresponds to 1.5/100V. The I²t value at the point “e” shifts upwardly on the graph and is 460 A²s, when the equivalent I²t value is normalized at five milliohms. When the I²t value is assumed to reach 5.06 times in terms of the sectional area at point “e”, the I²t value is 400A²s×5.06, which corresponds to 2328 A²s of the equivalent I²t value normalized at five milliohms. Since the value of 2328 A²s exceeds 1600 A²s of the equivalent I²t value of the practically-used earlier fuse, the value of 2328 A²s does not provide an appealing fuse under the assumption of the cost-increase of 1.5 times. However, when the dividing S-value is set to 10S, because the equivalent I²t value normalized at five milliohms becomes 330 A²s, and 330×5.06=1670A²s is attained, which corresponds to the practically-used earlier fuse, a good fuse is provided, making a complete change.

Although it depends on an estimation of the cost-increase rate of the manufacturing cost and an estimation of the decrease in the resistance value, the S-divisional effect can exhibit a sharp change as mentioned above. Under an assumption that the cost-increase rate of the manufacturing cost is about 1.5 times, the dividing S-value=9S is evaluated as a critical value that provides the significant effectiveness, from the industrial viewpoint in which the manufacturing cost is considered. More practically, the dividing S-value=10S becomes the critical value which provides the more significant effectiveness estimated from the industrial viewpoint.

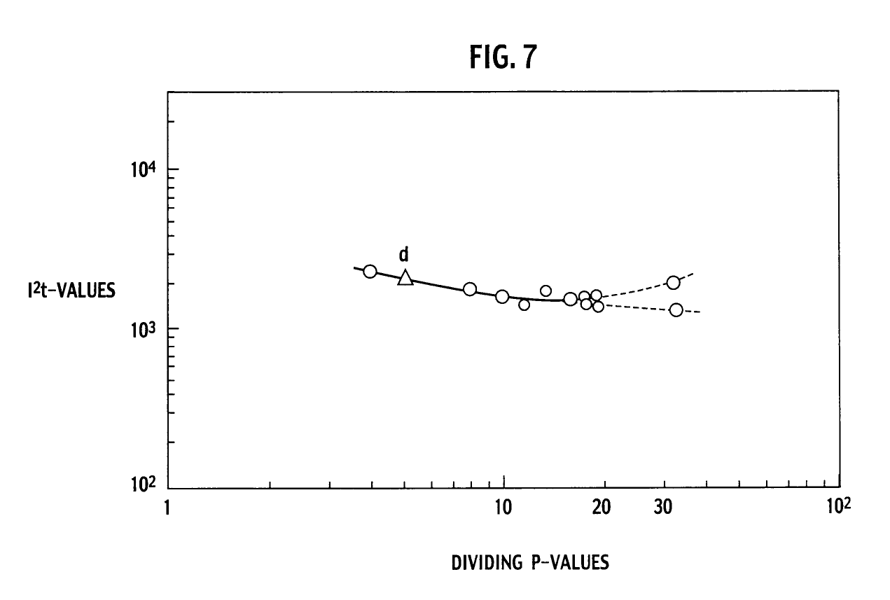

FIG. 7 illustrates the dividing P-value dependence characteristic of the total I²t value, in the case of S=6. As the dividing P-value increases, the total I²t value decreases, and the total I²t value becomes minimum at P=16, and the total I²t value increases again towards the case of P=32. In the fuse link in FIG. 7, the width of the interrupting grid measured in the parallel arrangement direction is eight millimeters. However, the re-increase in the dividing P-value is considered to be caused by the re-arcing in the interrupting grids 22₋₁, 22₋₂, 22₋₃, 22₋₍ₙ₋₁₎ and 22₋ₙ. Also, the thermal interference of the arcing point in association with the increase in the dividing P-value and the arc interference are considered. However, since the dividing S-value increases, as indicated by the dashed line in FIG. 7, the S-P synergistic effect can suppress those influences and avoid the total I²t value from being again increased.

Because the earlier AC600V fuse called “high performance fuse” with P=5 (6S5P-configuration) can be indicated at the point “d” in FIG. 7 with a total I²t=2160, by comparing with the total I²t=80 at point “c” (24S32P-configuration) in FIG. 6, c/d=80/2160 =1/29 is obtained. Thus, the significant improvement of the total I²t value over one digit or more is recognized in the AC600V fuse.

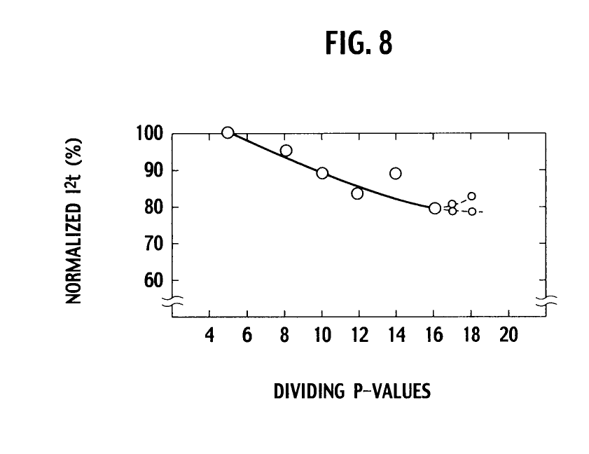

In the graph shown in FIG. 8, the I²t value of the fuse link of a 6S5P-configuration is assigned to be 100% so as to normalize the I²t value, and various I²t values of the fuse links having different dividing P-values are compared. As can be understood from FIG. 8, until 16P, the Pt value decreases with the increase of the dividing P-value, and when the dividing P-value further increases from 16P, because the variation in the experiment values becomes large, and the graph illustrates an unstable region. The P-divisional effect described in FIG. 7 and FIG. 8 is the steady-state phenomenon. In the case of the grounding rod, increasing the number of the rods leads to only a saturation characteristic. However, in the case of the P-divisional effect, not only the effect is saturated, but also the phenomenon becomes unstable as shown in FIG. 7 and FIG. 8 when the dividing P-value is further increased, and in the case of the further increase, there is a case that the effect is inverted, thereby increasing the I²t value. In the case of the grounding resistance, because only the steady-state phenomenon is analyzed, only a sequence of the parallel rods is treated. However, since the fuse link is responsible for cutting-off the current, the transient performance (current-interruption characteristic) shall be also examined. As to the phenomena of the current-interruption, the current-interruption is impossible only by a single narrow cut-off canal. Because the current-interruption operation is carried out by cooperation of the parallel arrangement of narrow cut-off canals, and a series arrangement of the parallel arrangement of narrow cut-off canals with the series number S, the transient performance must be examined through the current-interruption phenomena of with all of SP-values.

As shown on Table 1, at dividing S-value=245 with dividing P-value=8P, the equivalent I²t value normalized by five milliohms is 390 A²s. And, at dividing S-value=24S with dividing P-value=32P, because the equivalent I²t value normalized by five milliohms is 114 A²s as shown on Table 2, the ratio becomes 114/390≈1/4. If the S-divisional effect and the P-divisional effects are independent, because the equivalent I²t value resulting from the S-divisional effect at the time of 24S8P is 390, the equivalent I²t value would be only 312, even if 80% is multiplied in view of the saturated P-divisional effect 80% is multiplied. The difference results from “S-P synergistic effect”, in which the S-divisional effect prohibits the phenomenon of P-divisional effect from progressing into unstable region. “S-P synergistic effect” is considered to have an action for suppressing the re-arcing phenomenon, because the current-interruption performance in the parallel strips (interrupting grid) is improved by the influence of the S-divisional effect, in view of various experimentations by the present inventors.

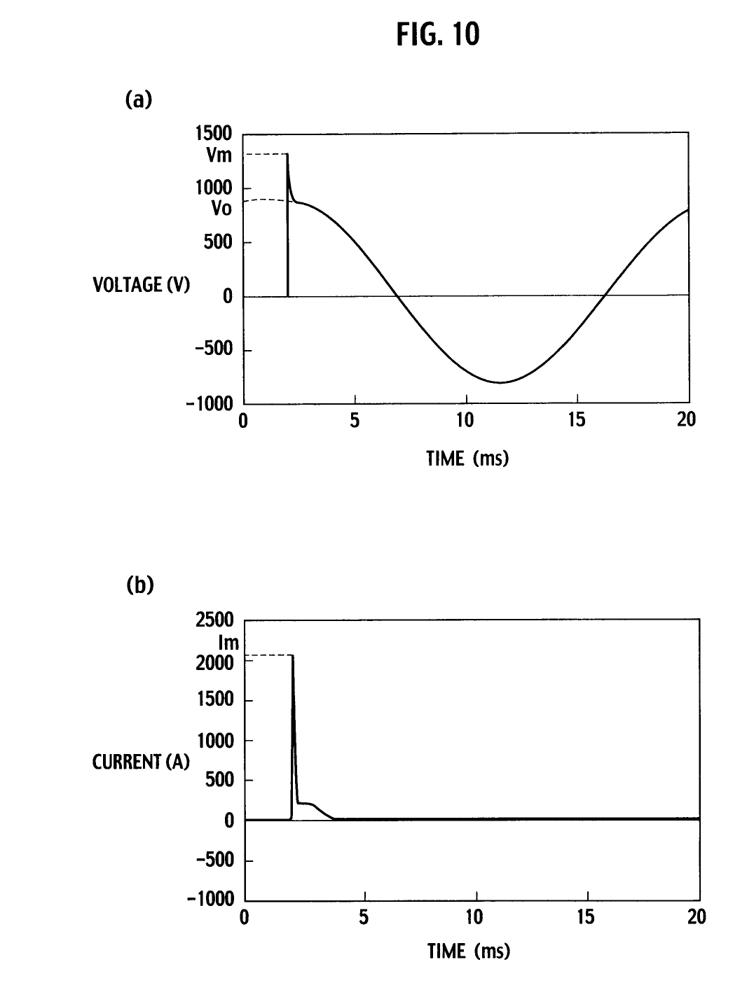

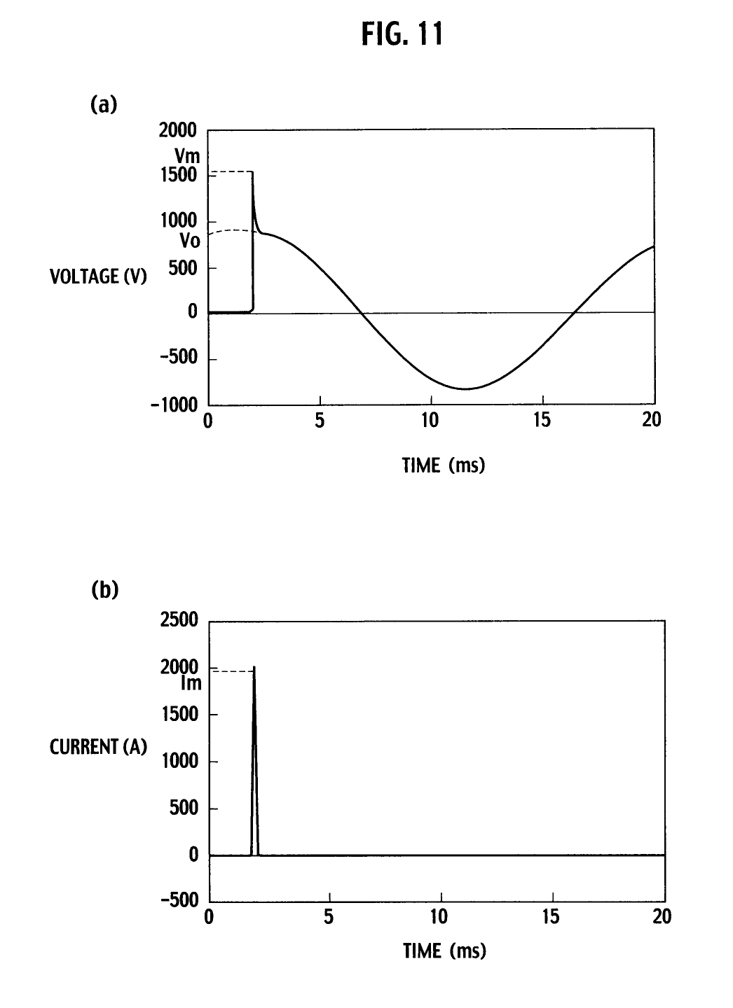

FIG. 9 illustrates an oscillogram waveform of the current-interruption experiment of the fuse of S=6, P=32 (6S32P-configuration). A protuberance is seen in a current waveform, which represents a generation of re-arcing. FIG. 10 illustrates the oscillogram waveform of the current-interruption experiment of a fuse of S=16, P=8 (16S8P-configuration) when the same current-interruption test circuit as FIG. 9 is used. Similarly, a protuberance is seen in the current waveform, and the re-arcing is generated. As shown in FIG. 11, in the case of S=24, P=8 (24S8P-configuration), in the current-interruption test executed by the same current-interruption test circuit as FIG. 9, the removal of the protuberance in the current waveform, which represents the suppression of the re-arcing. The fuse links shown in FIG. 9 to FIG. 11 have cut-off current values Iₘ=2000-80 A, which are tested by a current-interruption test circuit that has a rated voltage of 600V, a rated current of 40-60 A and an estimated short-current of 100 kA.

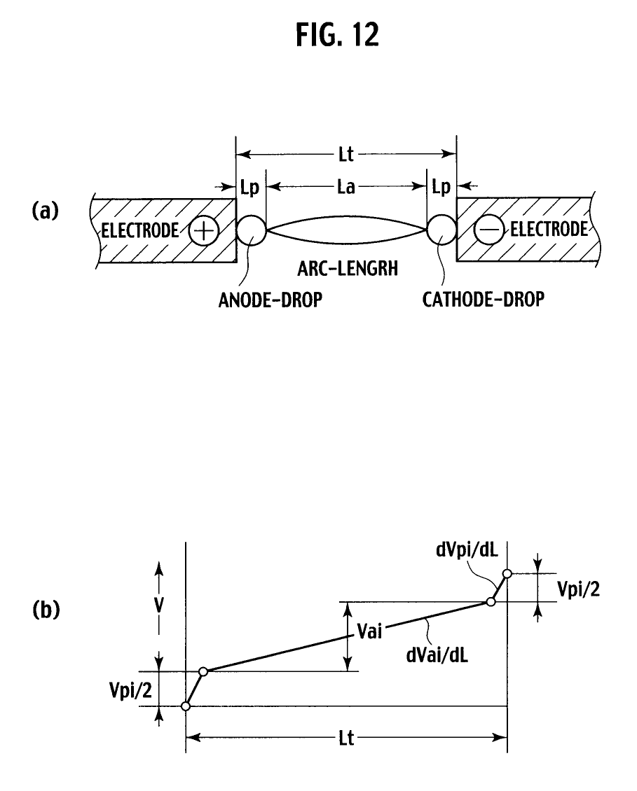

Focusing to a unit-fuse in the fuse link pertaining to the embodiment of the present invention so as to consider a single arc, an explanation shown in FIG. 12 is considered to be the best hypothesis. Although an electrode drop voltage Vₚ is known to be a voltage generated by space charges in a low voltage discharge regime, even in a case under a high temperature, a high voltage and a transient phenomenon such as a fuse arc phenomenon, whether or not a high electrode drop voltage is similarly generated is not known. There is a possibility that in a plasma drop, the increase effect of dv/dt, which is reversely proportional to the voltage, exists as the S-divisional effect. Here, the electrode drop voltage Vₚ is discussed. Under an assumption that the arc voltage of each fuse link is composed of an arc pillar voltage Vₐᵢ and an electrode drop voltage Vₚᵢ, the operation overvoltage Vₘ is obtained by:

Vₘ=ΣVₐᵢ+ΣVₚᵢ (3)

Here, the electrode drop voltage Vₚᵢ is the sum of a cathode electrode drop voltage Vₚᵢ/2 and an anode drop voltage Vₚᵢ/2. Specifically:

Constructive-equation for 4S8P Fuse: Vₘ₄=ΣVₐ₄+ΣVₚ₄ (4a)

Constructive-equation for 8S8P Fuse: Vₘ₈=ΣVₐ₈+ΣVₚ₈ (5a)

Constructive-equation for 12S8P Fuse: Vₘ₁₂=ΣVₐ₁₂+ΣVₚ₁₂ (6a)

Constructive-equation for 16S8P Fuse: Vₘ₁₆=ΣVₐ₁₆+ΣVₚ₁₆ (7a)

Constructive-equation for 24S8P Fuse: Vₘ₂₄=ΣVₐ₂₄+ΣVₚ₂₄ (8a)

Here, when the experiment values on Table 1 are substituted into Eqs. (4a) to (8a), respectively, Eqs. (4b) to (8b) are obtained:

918V=4Vₐ₄+4Vₚ₄ (4b)

1072V=8Vₐ₈+8Vₚ₈ (5b)

1260V=12Vₐ₁₂+12Vₚ₁₂ (6b)

1347V=16Vₐ₁₆+16Vₚ₁₆ (7b)

1938V=24Vₐ₂₄+24Vₚ₂₄ (8b)

In Eqs. (4b) to (8b), because the current flowing through the arc pillar is determined by an external parameter, and determined to be constant, in order to make entire arc lengths ΣLt equal, the L in the entire melting-length ΣL may be reduced in accordance with a reverse ratio of the division number. This results in the same value as follows:

4Vₐ₄=8Vₐ₈=12Vₐ₁₂=16Vₐ₁₆=24Vₐ₂₄ (9)

Thus, when {“Eq. (5b)”-“Eq. (4b)”} is calculated, the following Eq. (10) is obtained:

8Vₚ₈−4Vₚ₄=1072V−918V=154V (10)

Also, the electrode drop voltage Vₚᵢ is considered to have the approximately same value, as long as the same arc current flows. As the values of the electrode drop voltages Vₚᵢ neighboring configuration to each other, such as 4S8P to 8S8P-configuration and 8S8P to 12S12P-configuration, can be considered to having further close values, the following Eq. (11) is obtained:

Vₚ₄≈Vₚ₈, Vₚ₈≈Vₚ₁₂, Vₚ₁₂≈Vₚ₁₆, Vₚ₁₆≠Vₚ₂₄ (11)

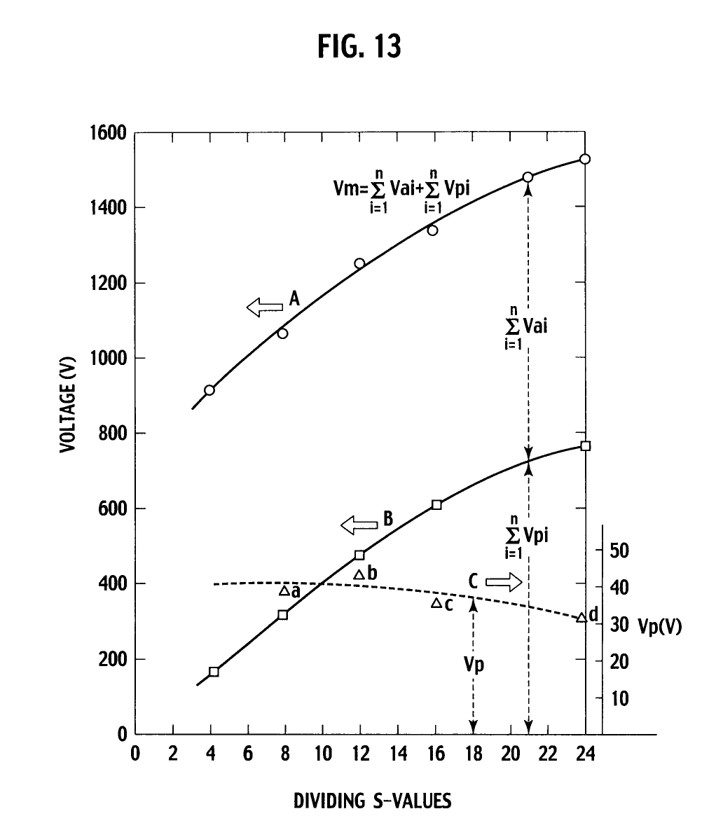

Since Eq. (10) may be roughly approximated to be Vₚ₈=159V, Vₚ₄=Vₚ₈=38.5V is obtained. Similarly, the values of Vₚ₁₂, Vₚ₁₂ and Vₚ₂₄ are calculated, and the values of Vₚ₈, Vₚ₁₂, Vₚ₁₂ and Vₚ₂₄ are plotted on FIG. 13, as the points “a”, “b”, “c” and “d”. In FIG. 13, the characteristic determined by the points “a”, “b”, “c” and “d” is indicated by a dotted line C. Moreover, the operation overvoltages Vₘ measured in Table 1 are plotted as indicated by a characteristic curve A. After obtaining the Vₚ values form the operation overvoltages Vₘ, each of the Vₚ value is multiplied by the respective division numbers so as to obtain the total electrode drop values ΣVₚ, and the calculated total electrode drop values ΣVₚ are plotted as shown in FIG. 13, which is indicated by a characteristic curve B. Thus, the difference between the characteristic curve A and the characteristic curve B becomes an arc characteristic Vₐ and exhibits a constant value between 4S and 24S, while the characteristic curve C, which represents the electrode drop characteristic, decreases with the dividing S-values and illustrates a slightly smaller value at a short arc of 24S. The slight saturation characteristic of the S-divisional effect of the I²t value is very similar to the slight saturation of the characteristic curve C.

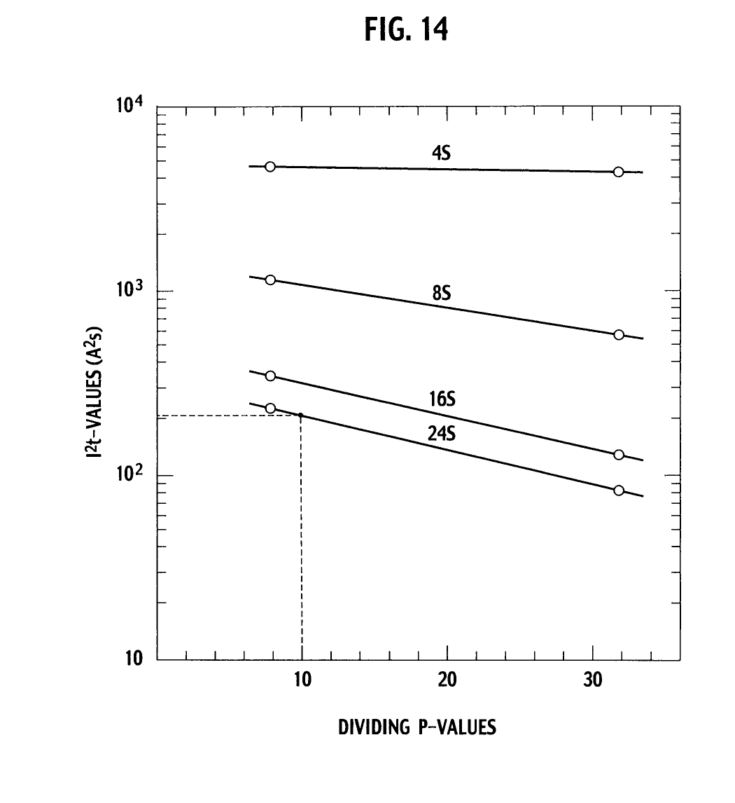

The graphs shown in FIG. 14 are introduced from the data shown in FIG. 6, and abscissa indicates the dividing P-values, and the dividing S-values are represented as the parameter. Because the P-divisional effect provides more gradual changes than the S-divisional effect, linear approximations are represented on double logarithm graph. As normalized by five milliohms, the equivalent I²t value at point “10P” on the characteristic curve of the dividing S-value 24S as the parameter shifts upwardly on the graph FIG. 14 so as to provide a value of 280 A²s. As mentioned above, the minimum sectional area is required to be multiplied by (1.5)², when the decrease in the resistance value is estimated from the cost-increase rate of the manufacturing cost, because the rated current value must be multiplied by 1.5. As the rated current value is multiplied by 1.5, because the I²t value increases by 5.06 times, the equivalent I²t value normalized by five milliohms is 280×5.06 times =1417 A²s. The value of 1417 A²s still has the slight superiority, such as 1417/1600=89%, as compared with the practically-used earlier fuse. Thus, from the industrial viewpoint in which the manufacturing cost is considered, the division P value of ten is evaluated as the critical value that provides the significant effectiveness, which corresponds to the value of 12 P/cm.

Specifically, although the dividing S-values of the AC600V fuse are elected between 6S and 7S, as the common sense in the earlier technology, according to the fuse link pertaining to the embodiment of the present invention, the AC600V fuse can have the dividing S-values of between 24S and 32S. Also, for the AC6000V fuse, although the dividing S-values are elected between 60S and 70S, in the design of earlier common sense, according to the fuse link pertaining to the embodiment of the present invention, the dividing S-values can be elected between 148S and 198S.

### (Packaged Structure)

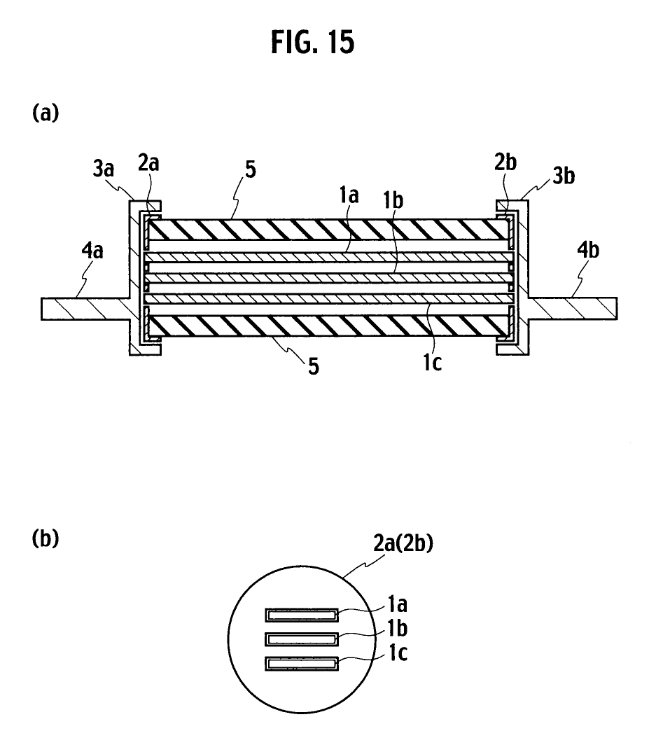

FIG. 15 illustrates an example of the packaged structure of the fuse link pertaining to the embodiment of the present invention. In FIG. 15, three pieces of fuse links 1a, 1b and 1c are fixed through rectangular slits provided in inner caps 2a, 2b. Then, in such a way that both ends of an insulating tube 5 can be sealed, both ends of the insulating tube 5 are covered by the inner caps 2a, 2b, and then, outer caps 3a, 3b, which have fuse terminals 4a, 4b, respectively, are engaged so as to cover the outer sides of the inner caps 2a, 2b, so that a fuse cylinder can be assembled.

As mentioned above, according to the fuse link pertaining to the embodiment of the present invention, because the total I²t value can be reduced to 1/10 of the earlier fuse, the current margin occurs in the in the designing of a fuse. For this reason, it is possible to increase the rated current, by widening the minimum width b of the narrow cut-off canal, while holding the total I²t value at the desirable value or less. That is, because it is also easy to double the rated current flowing through a single fuse link, as shown in FIG. 15, the number of the fuse links installed in the packaged structure of the fuse link can be reduced to ½ or less, and therefore, it is possible to miniaturize the packaged structure (fuse cylinder), facilitating the reduction of manufacturing cost.

### Other Embodiment

While the present invention is described in accordance with the aforementioned embodiment, it should not be understood that the description and drawings that implement a part of the disclosure are to limit the scope of the present invention. In view of aforementioned disclosure, it will be clear that there are a variety of alternative embodiments, examples and operational techniques for those skilled in the art. Therefore, the present invention may naturally include various embodiments not described herein, and the technical scope of the present invention should be defined only by features for specifying the invention according to the appended claims that are regarded appropriate according to the above description.

### INDUSTRIAL APPLICABILITY

The fuse link according to the present invention can be used in the fields of a power supply for a large electric power, a high power DC-DC converter, a high power DC-AC converter, a high power AC-DC converter, a general inverter, an uninterruptible power supply, a power supply for a motor control of a vehicle such as a car, an electric train and the like, a power supply for a motor control of a ship, a power supply for driving various industrial motors, a power electronics equipment such as an NC machine, a robot and the like, or those power supplies, and an electric power control system of a power electronics equipment and a peripheral apparatus thereof, as the fuse for protecting the semiconductor switching device such as the GTO thyristor, the IGBT and the like.

1. A fuse link comprising:
an insulating substrate; and
a pattern of a conductive thin film formed on a surface of the insulating substrate, the pattern of the conductive thin film includes:
a plurality of patterns of interrupting grids, each of which having a plurality of narrow cut-off canals arranged in parallel, and
a plurality of patterns of jointing zones connecting the interrupting grids alternately and cyclically so that the interrupting grids are arrayed in series through jointing zones,
wherein each of the interrupting grid has a thickness between 10 and 60 micrometers, each of the jointing zone has a thickness between 80 and 150 micrometers, and a length measured in the series direction of the jointing zone is 2.5 millimeters or less.

2. The fuse link of claim 1, wherein a number of the series connections of the interrupting grids is 1.5 or more per 100V.

3. The fuse link of claim 1, wherein a parallel number of the narrow cut-off canals is 12 or more per cm of a width of the interrupting grid measured in the parallel direction.

4. The fuse link of claim 2, wherein a parallel number of the narrow cut-off canals is 12 or more per cm of a width of the interrupting grid measured in the parallel direction.

5. A fuse comprising:
an insulating tube serving as a fuse cylinder; and
a fuse link installed in the insulating tube, the fuse link having:
an insulating substrate; and
a pattern of a conductive thin film formed on a surface of the insulating substrate, the pattern of the conductive thin film includes:
a plurality of patterns of interrupting grids, each of which having a plurality of narrow cut-off canals arranged in parallel, and
a plurality of patterns of jointing zones connecting the interrupting grids alternately and cyclically so that the interrupting grids are arrayed in series through jointing zones,
wherein each of the interrupting grid has a thickness between 10 and 60 micrometers, each of the jointing zone has a thickness between 80 and 150 micrometers, and a length measured in the series direction of the jointing zone is 2.5 millimeters or less.

6. The fuse of claim 5, wherein a plurality of the fuse links are connected in parallel and installed in the insulating tube.

7. The fuse of claim 5, wherein a number of the series connections of the interrupting grids is 1.5 or more per 100V.

8. The fuse of claim 5, wherein a parallel number of the narrow cut-off canals is 12 or more per cm of a width of the interrupting grid measured in the parallel direction.

9. The fuse of claim 7, wherein a parallel number of the narrow cut-off canals is 12 or more per cm of a width of the interrupting grid measured in the parallel direction.
